(19) United States
(12) Patent Application Publication
(10) Pub. No.: US 2009/0319601 A1
(43) Pub. Date: Dec. 24, 2009

(54) SYSTEMS AND METHODS FOR PROVIDING REAL-TIME VIDEO COMPARISON

(76) Inventors: Frayne Raymond Zvonaric, Salt Lake City, UT (US); Oliver C. Moore, III, Salt Lake City, UT (US)

Correspondence Address: KIRTON AND MCCONKIE, 60 EAST SOUTH TEMPLE,, SUITE 1800, SALT LAKE CITY, UT, 84111, US

(21) Appl. No.: 12/143,790

(22) Filed: Jun. 22, 2008

(51) Int. Cl. G06F 15/16

(52) U.S. Cl. 709/203

(57) ABSTRACT

Two or more performers, contestants, or commentators each perform in separate geographical locations. The performances are captured in via media recording devices and are delivered to a website that manages collection and distribution of performance data. The website creates a webpage that is delivered back to each performer; a webpage is also made available to third party spectators who can see two or more performance. Such third party spectators can compare the multiple performances presented on a single webpage and provide feedback in the nature of ratings, votes, commentary, and other feedback, which feedback may be summarized, averaged, or otherwise analyzed, and presented in raw or summarized/analyzed form to other third party spectators, or to one or more performers. Performance and comparison data created by third party spectators may be archived for later review, further comparison or ratings, or for other uses.

### BACKGROUND OF THE INVENTION

1. Field of the Invention

The present invention relates to dynamically delivering content for comparison. More particularly, the present invention relates to systems and methods for delivering online content in real-time and enabling comparisons of that content by others.

2. Background and Related Art

Historically, a variety of media has been used to provide entertainment to users. For example, such media includes radio and television. In the music industry, radio has been utilized to broadcast music to the listening audience. When exposed to the music, listeners are able to determine their appeal for particular songs and/or musical groups/performers. Television has similarly allowed music performers to have their songs broadcast to listeners, and has enabled the performers to introduce their music to the viewing public. While radio and television broadcast musical entertainment to individuals, the viewing/listening audience is reliant on the particular station programming for their musical exposure. If a listener does not like a particular station programming, one option available is to change the channel or station to see if another station programming is more appealing to the listener.

Pre-recorded music available on media, such as on a CD, allows a user to listen to particular performances, songs, and performers that have been recorded on that media. More recently, mp3 players are utilized to listen to music that is in a digital format. Such options are available for pre-recorded music, not live performances.

Thus, while techniques currently exist that are used to provide entertainment to users, challenges still exist. Accordingly, it would be an improvement in the art to augment or even replace current techniques with other techniques.

### SUMMARY OF THE INVENTION

The present invention relates to dynamically delivering content for comparison. More particularly, the present invention relates to systems and methods for delivering online content in real-time and enabling comparisons of that content by others.

Implementation of the present invention takes place in association with using one or more computers within a computer system and/or network. In one implementation, two or more individuals, groups or performers, such as musical performers, each perform in separate locations. Such performances are captured in real-time and delivered to a website that manages collection and distribution of performance data. The website creates a webpage that is delivered back to each performer so that each performer can see one or more other performers in real-time (as performances are taking place).

The website creates a webpage that third party spectators/viewers can access and on which they can see two or more simultaneous live performances. Facilities are provided to permit such third party spectators to compare the multiple real-time or live performances visible on a single webpage, and to provide feedback in the nature of ratings, votes, commentary, and other feedback, which feedback may be summarized, averaged, or otherwise analyzed, and presented in raw or summarized/analyzed form to other third party spectators, and/or to one or more performers. Performance and comparison data created by third party spectators may be archived for later review, further comparison, analysis or ratings, or for other uses.

In some implementations, a host or moderator, whether an individual and/or a system, is included to introduce the particular performers, manage the sequence of performance by the performers, respond to the audience, manage the comparison from the audience, and/or otherwise manage, oversee, provide, augment, supervise, present and/or regulate the content and/or entertainment experience.

While the systems and methods of the present invention have proven to be particularly useful for facilitating third party comparison or rating of multiple real-time performance fees, those skilled in the art can appreciate that the systems and methods can be used in a variety of different applications and in a variety of different areas. Such examples include providing pre-recorded performances from one or more groups/performers for comparison, enabling the comparison of non-musical content, allowing for a testing environment for content that enables a rating of the particular content, etc.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use in accordance with embodiments of the present invention;

FIG. 2 illustrates a representative networked system that provides a suitable environment for use in accordance with embodiments of the invention;

FIG. 3 illustrates a representative embodiment of a system for providing real-time video comparison; and

FIGS. 4-7 illustrate representative embodiments of a webpage that provides real-time video comparison.

### DETAILED DESCRIPTION OF THE INVENTION

The present invention relates to dynamically delivering content for comparison. More particularly, the present invention relates to systems and methods for delivering online content and enabling comparisons of that content by others.

The following disclosure of the present invention is grouped into four subheadings, namely “Representative Operating Environment,” “Real-time Video Comparison,” “Real-time Video Comparison Website,” and “Website Technology.” The utilization of the subheadings and subsections is for convenience only and is not to be construed as limiting in any sense.

### Representative Operating Environment

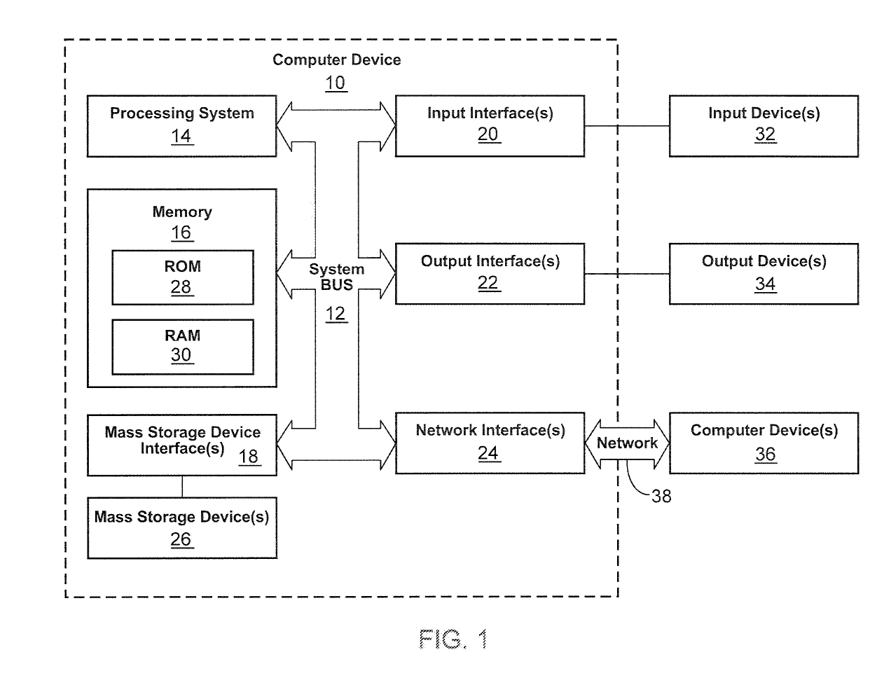

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a tablet computer, a personal digital assistant (“PDA”), or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a microphone, a joystick, a game pad, a satellite dish, a scanner, a camcorder, a digital camera, a tactile input device, and the like. Some examples of tactile input devices can include a keyboard and alternate input devices, such as a mouse, trackball, light pen, stylus, touchpad, touch-screen, or any other suitable pointing device. Similarly, examples of input interfaces 20 that may be used to connect the input devices 32 to the system bus 12 include a serial port, a parallel port, a game port, a universal serial bus (“USB”), a fire wire (IEEE 1394), or another interface.

One or more output interfaces 22 may be employed to connect one or more corresponding output devices 34 to system bus 12. Examples of output devices include a speaker, a printer, a visually perceptible output device (e.g., a monitor, display screen, or any other suitable visualization device), and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

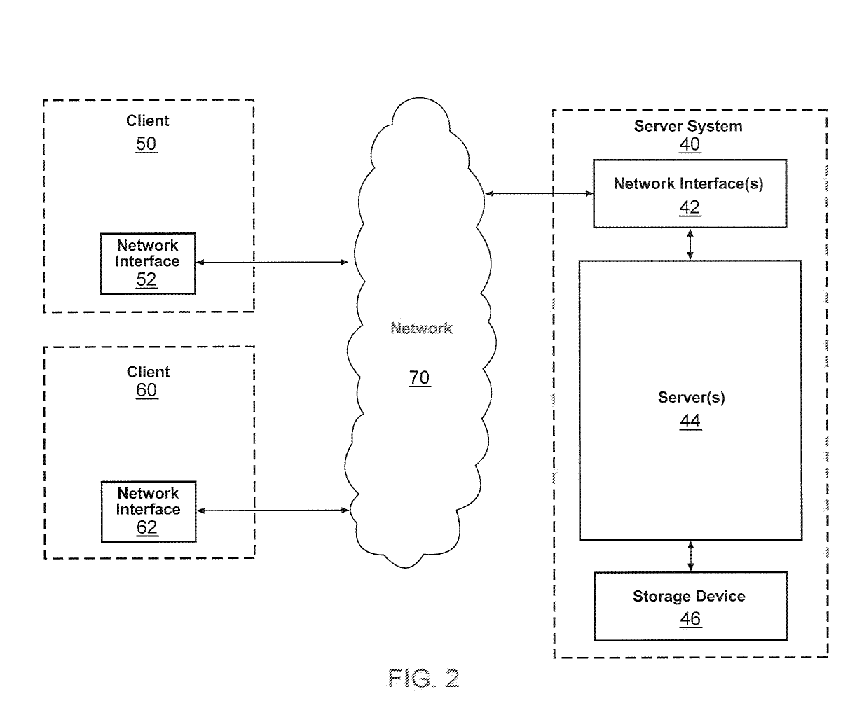

While those skilled in the art will appreciate that the invention may be practiced in networked computing environments with many types of computer system configurations, FIG. 2 represents an embodiment of the present invention in a networked environment that includes clients 50 and 60 connected to a server system 40 via a network 70. While FIG. 2 illustrates an embodiment that includes two clients connected to the network, alternative embodiments include one client connected to a network or many clients connected to a network. Moreover, embodiments in accordance with the present invention also include a multitude of clients throughout the world connected to a network, where the network is a wide area network, such as the Internet.

### Real-Time Video Comparison

As provided above, embodiments of the present invention relate to dynamically delivering content. More particularly, embodiments of the present invention relate to systems and methods for delivering online content in real-time and enabling comparisons of that content by others.

In one embodiment, two or more individuals, groups or performers engage in a virtual exchange via a communication network application, such as a website. In a further embodiment, the two or more individuals, groups or performers are in geographically different locations. The network application allows third parties, such as viewers, professionals, or other third parties, to observe the exchange and compare the two or more individuals, groups or performers. In some embodiments, third party observers rate, judge, or vote for the individuals, groups or performers to express an opinion regarding the activities, qualities, or characteristics of each (the foregoing being examples of comparison metrics that may be provided).

While the above example refers to two or more individuals, groups or performers, one of skill in the art will recognize that embodiments of the present invention embrace one or more individuals, groups or performers in a contest. In one embodiment, a contest involves a single person, and one or more third party observers critique and compare that person's performance. In another embodiment, a contest involves three persons and/or groups each competing against each other. In other embodiments, more than three persons and/or groups compete. In one embodiment, two or more persons or groups in different geographic locations form a team and compete against one or more persons, groups, or other combined teams. While any number of people or groups can be included in a contest, the following description will frequently make reference to a contest between two people. These descriptions are merely for representative purposes.

Further embodiments of the present invention embrace a host or moderator, whether an individual and/or a system, that is used to introduce the particular individuals, groups, performers or competitors, manage the sequence of performance by the performers, respond to the audience, manage the comparison from the audience, and/or otherwise manage, oversee, provide, augment, supervise, present and/or regulate the content and/or entertainment experience. In a further embodiment, while one individual, group, performer or competitor performs in the competition, the video and/or audio of other individuals, groups, performers or competitors is blocked or muted to prevent disruption to the performance of the current performer. The moderator introduces the performers, regulates the competition, provides announcements and insights, and identifies the winner of the competition.

Embodiments of the present invention embrace facilitating any suitable exchange, comparison, dialog, performance, contest, or similar venue between two or more individuals, groups, performers or competitors. For example, in some embodiments, the contest is a rapping contest conducted between two rap music artists who, either simultaneously or in turn, perform musically or vocally. These artists can freestyle rap or use a previously composed script. In one embodiment, these artists exchange insults, or other competing language or expressions, targeted towards the other artist. Each artist has a time period to rap followed by a time where the other artist must build upon or continue the rap started by the first. Many types of rap contests or competitions can be conducted using embodiments of the present invention. While the previous example refers to a rap contest, those of ordinary skill in the art will appreciate that such an example is representative only and that embodiments of the present invention embrace any type of competition, comparison or judgment that can be rendered using a computer device, including any competition, comparison or judgment having an audio, video, text and/or graphic component.

In some embodiments, the exchange between two or more individuals, groups, performers or competitors comprises a debate. For example, a debate between political candidates. In another example the debate is between one or more debate teams. In another example the debate is between two commentators debating over an issue of current importance to viewers/listeners of the debate. In another embodiment, the contest is a talent competition between two or more contestants. In yet another embodiment, the contest is a sports or exercise competition. Each of these embodiments is merely exemplary, and a person of skill in the art will recognize that a number of other types of exchanges, dialogs, or comparisons can be conducted and are enforced by embodiments of the present invention.

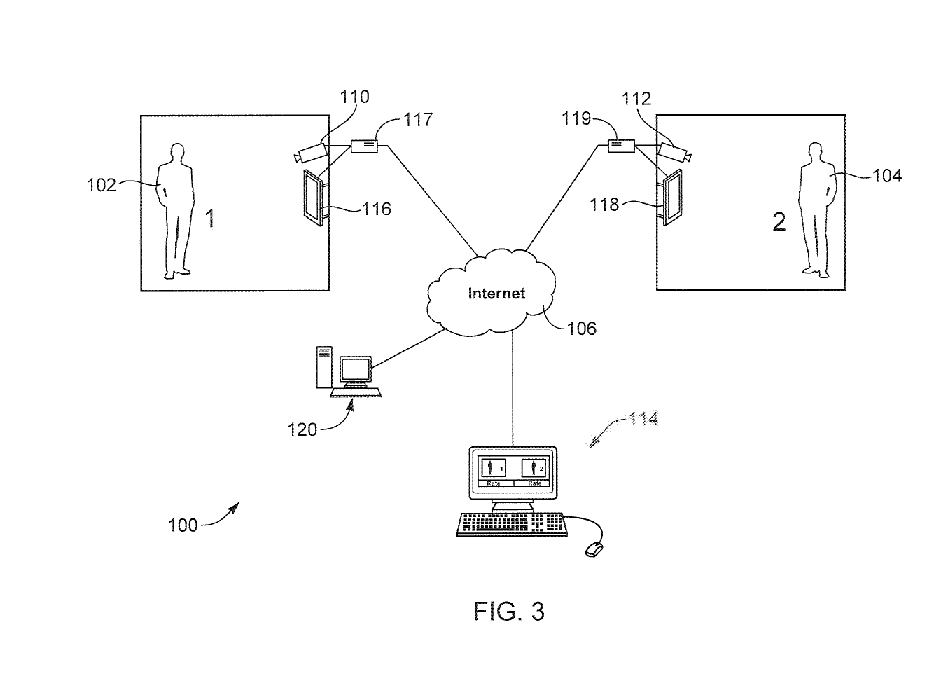

FIG. 3 shows a representative embodiment 100, where a first party 102 engages a second party 104 in a virtual exchange. Information about each party's performance is transferred over a network, such as internet 106, and each party observes the other party's performance in real-time. Where the exchange is competitive in nature, the outcome of the competition or contest may be determined in several ways and each of the first party and second party may be regarded as contestants.

In one embodiment, a third party accesses a designated website, using a computer device 114 connected to the Internet and observes the exchange in real-time. During or after the exchange, the third party makes a comparison of the contestants. This comparison includes any number of embodiments. For example, in one embodiment the comparison is a rating of one or all of the contestants. In another embodiment, the comparison is a vote that indicates which contestant should win the contest. In yet another embodiment, the comparison is a written comment or critique. In yet another embodiment, the comparison is a recorded, multimedia critique that may be uploaded onto the network application for review by the contestants. And in yet another embodiment, the comparison is a real-time, multimedia critique that may be transferred to the network application and viewed by the contestants.

Comparisons or critiques of the contestants provided by a third party in this embodiment may be accessible only to the contestant to whom the comparison is directed, or only to the other contestants, or only to all contestants, or only to other third parties, or to any combination of the above.

A person of skill in the art will recognize that embodiments of the present invention embrace a variety of system configurations, including a variety of networked system configurations. One such example comprises using a client server application, downloaded from the internet, to run on the client's machine if their bandwidth cannot handle the real-time lag. However, the following representative description is in the context of the internet, the world wide web, and a website application. Furthermore, a person of skill in the art will recognize that references in this exemplary embodiment may be generalized to refer to any number of participants engaged in the described exchange, and may further be generalized to refer to participants engaged in any number of diverse exchanges comprised within the broader scope of the present invention, including but not limited to those representative embodiments set forth above.

To provide for a virtual contest in this representative embodiment, each of the first and second contestants transfers information to the other contestant over the Internet 106 via a master server 120. In one embodiment, the transferred information is audio and video information, such as information recorded and sent via a webcam, video cameras 110 and 112, cell phone, or other audio and/or video device. In another embodiment, the transferred information is purely video information, such as information recorded using a webcam, video camera, cell phone, or like device that does not record sound or is configured to record only video. In another embodiment, the transferred information is purely audio information. In yet another embodiment, the transferred information is text. A person of skill in the art will recognize that the system and method described herein are equally capable of application using pure video, purely audio, text, and other such information being transferred between contestants in any of a large variety of data formats presently used or yet to be developed; however, the following description will be in the context of audio and/or video information/content.

As shown in FIG. 3, a first party 102 participates in a contest against a second party 104. The first party 102 performs adjacent to a video camera 110 that captures his performance and transfers it as a video stream in real-time or substantially in real-time over the Internet 106 using computer device 117 and via a designated master server 120, to the second party 104, who may view the performance of the first party 102 within a webpage. In one embodiment the first party 102 and the second party 104 each have display screens 116 and 118 provided via corresponding computer devices 117 and 119, so that each can view the performance of the other party. In addition, an audio playback device (not shown) may either be included as part of the display device 116, 118 or as a separate component for playing audio data captured at the other party's location. This audio data can be captured by the video camera 110 or a separate microphone device (not shown) and transmitted by the computer processing unit 117 to the master server 120. For example, the video image and audio data of the performance of the first party 102 is captured by video camera 110 as a video stream using computer processing unit 117, transferred over the Internet 106 to master server 120, and then onward via web server software located on master server 120 to be received by a web browser or other network-aware application located on computer processing unit 119, where the performance of the first party 102 is displayed on the display screen 118 of the second party 104 in real-time. In a similar manner, and potentially simultaneously, the image and audio data comprising the performance of the second party 104 is captured by webcam 112 using computer device 119, transferred over the Internet 106 to master server 120, and then onward via web server software located on master server 120 to be received by a web browser or other network-aware application located on computer processing unit 117, where the performance of the second party 104 is displayed on display screen 116 of the first party 102 in real-time. Using this arrangement, the two or more parties communicate with each other, view and hear the other party's performance, and respond in real-time. In some embodiments, the display screens 116 and 118 are computer monitors. In other embodiments, the display screen is a television screen, or other like display device, that receives a video feed from a computer with an Internet connection.

In some embodiments, the virtual contest can be accessed, reviewed, and compared on a designated website by one or more third parties. For example, a third party can access the website that is promulgated by master server 120 and observe the contest, including listening and/or observing in real-time as the first party 102 and the second party 104 are performing. In some embodiment, third party observation includes the third party listening to and viewing the contestants to the contest. For example, in a contest between two musical artists, a third party can access a designated website and watch the contest in real-time. The website used in such an embodiment displays two video images, one originating from the location where each of the musical artists is performing, and also plays corresponding audio data in real-time that originates from each musical artist. Both the video images and audio data are played in real-time so that a third party observer can witness the contest in real-time and make a comparison of the contestants, either in real-time or after the contest has concluded.

As provided above, embodiments of the present invention embrace a host or moderator, whether an individual and/or a system, that is used to introduce the particular individuals, groups, performers or competitors, manage the sequence of performance by the performers, respond to the audience, manage the comparison from the audience, and/or otherwise manage, oversee, provide, augment, supervise, present and/or regulate the content and/or entertainment experience. In a further embodiment, while one individual, group, performer or competitor performs in the competition, the video and/or audio of other individuals, groups, performers or competitors is blocked or muted to prevent disruption to the performance of the current performer. The moderator introduces the performers, regulates the competition, provides announcements and insights, and identifies the winner of the competition. In some embodiments, a third-party host directs the affairs of the competition. For example, in some embodiments, a third-party host acts as a referee, a mediator, a judge, critic, etc. In one embodiment, a webpage displays the third-party host to the contestants and/or a third party observer(s).

### Realtime Video Comparison Website

A description will now be given to illustrate embodiments of a website according to at least some embodiments of the present invention that facilitate real-time virtual contests. In general, the website permits users to engage in virtual contests by providing means for two or more people to engage in a contest from two locations. The website requires each contestant to have the necessary equipment for capturing, transferring, and displaying video and audio data to a website hosted on one or more master servers (the “website”), as described in greater detail below. This video and audio data is sent to a website, from which it is transferred to the computer of an opposing contestant, and displayed to opposing contestants. In addition, one or more third party users may access the website, viewing in real-time the information streams generated by contestants and observing the contest from a third geographic location. These third party viewers may then compare the contestants. A number of website features, interfaces, and/or functions can be included with the website, as hosted by the master server or servers, to facilitate a user's experience with the website. These feature, interfaces, and function will be described in this subsection.

While the embodiments discussed herein refer to a master server, the present invention also comprises embodiments in which peer-to-peer access permits sharing of a contestant's data with other contestants and with third parties without the need of a master server.

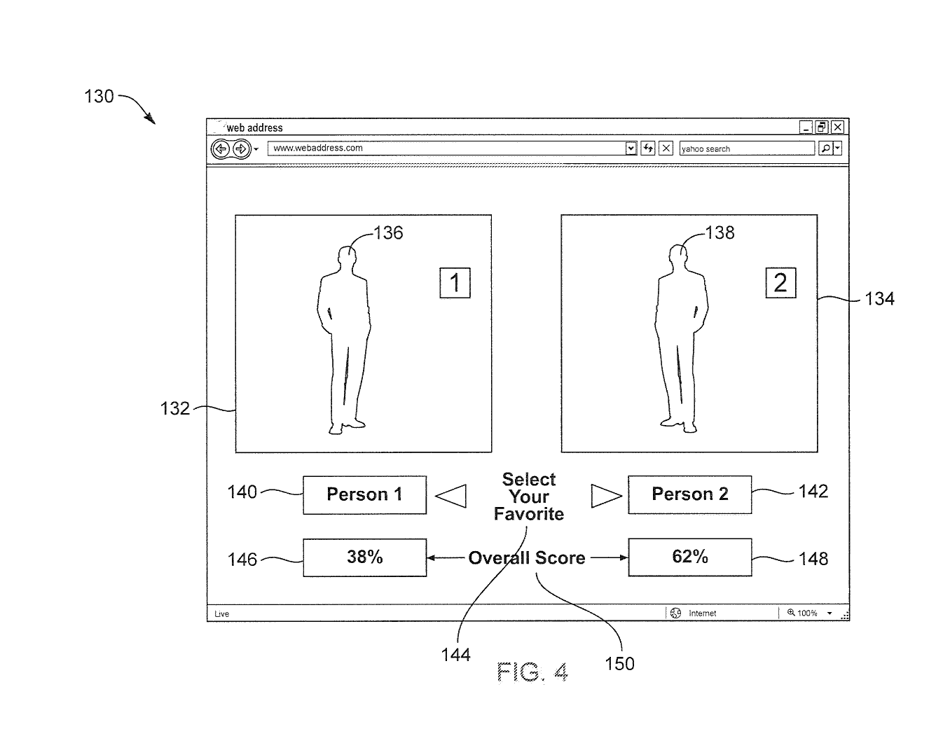

In some embodiments, the website permits a third party observer to access the website and view an ongoing contest. In some embodiments, the website displays a webpage that include real-time video images of both contestants while also streaming real-time audio data of both contestants. FIG. 4 illustrates an embodiment of such a webpage 130. The webpage 130 include two video boxes 132 and 134, which simultaneously display videos of contestant one 136 and contestant two 138, respectively. From the webpage 130 a third party observer can watch the entire contest. The webpage 130 also provides means for the third party to compare the contestants.

In one embodiment, this comparison is a vote. As shown in FIG. 4, the third party observer selects a favorite contestant or a winner by selecting either a first button 140, which records a vote for contestant one 136, or a second button 142, which records a vote for contestant two 138. These buttons are selected by clicking on them with a mouse or other indicator/voting means, including a controller, email, text messaging, instant messaging, etc. In some embodiments, many third parties submit comparison data and the webpage 130 displays the results or sum of all third party comparison. In one embodiment, the webpage 130 displays an overall score 150, which is represented by the percentage 146 and 148 of all third party observers who vote for each contestant.

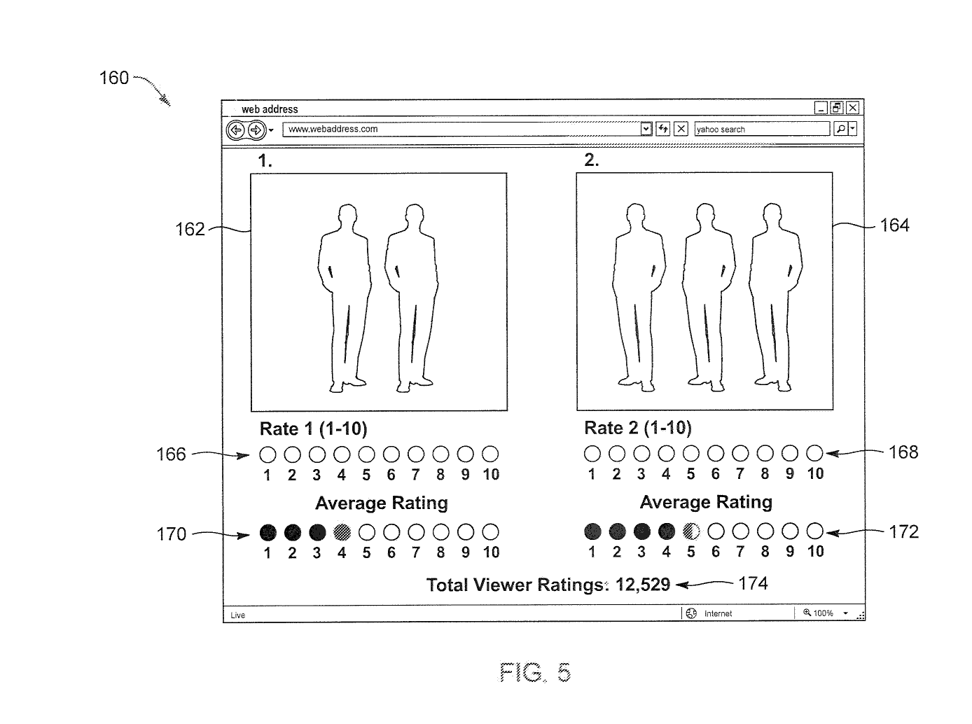

FIG. 5 illustrates another embodiment of a webpage 160 that displays two video boxes 162 and 164, which display videos of a first group competing against a second group. In this embodiment, a third party observer rates one or both groups by giving each group a score between one and ten. This score is entered by selecting an icon that represents the desired rating from a plurality of icons 166 and 168. In one embodiment, the webpage displays the average rating 170 and 172 for each group, as well as the total number of third party observers who have voted 174. Once the contest is over, the group with the highest rating is the winner.

In some embodiments, a webpage displaying a contest includes a chat window. The chat window allows one or more third party observers to write comparison information into a chat window. In some embodiments, the comparison information written by a third party observer replaces all votes, ratings, or other such feedback that is provided by a user. In this way no specific contestant or group is declared the winner, but each receives the comments written into the chat window by the third parties. In one embodiment, the chat window is displayed to all users observing a contest. In another embodiment, the chat window is displayed only to users who contribute or sign onto the chat session. In yet another embodiment, the chat window is displayed to all parties viewing the contest, but is only contributed to by a select individual or group. The select group can be, for example, one or more well known critics or commentators.

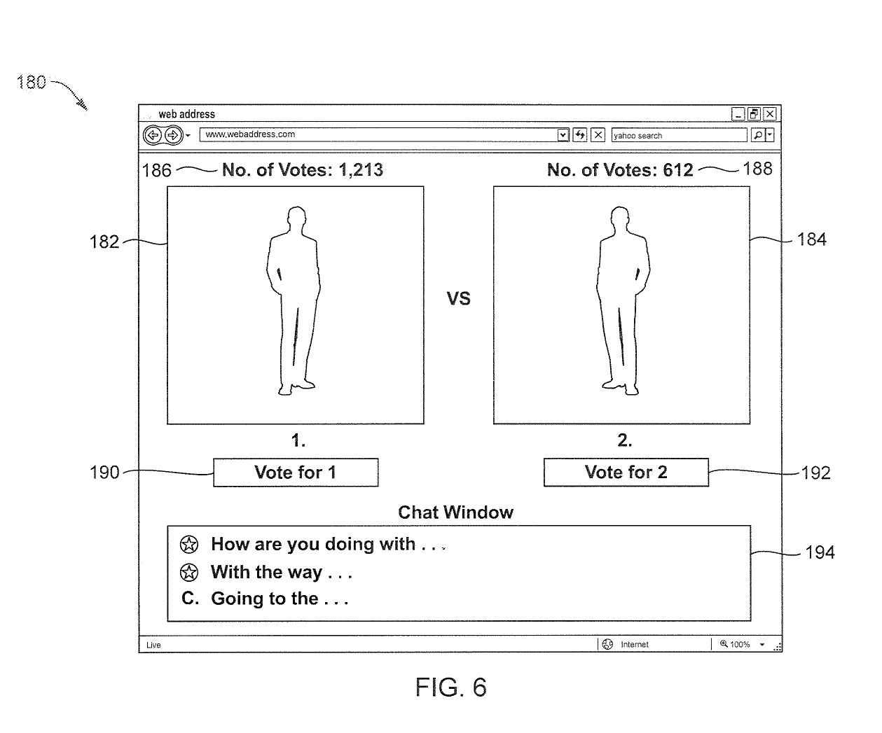

FIG. 6 illustrates an embodiment of a webpage 180, which includes a chat window 194. As in FIGS. 4-5 the webpage 180 displays two videos 182 and 184 of the contestants in a contest. Below the video boxes 182 and 184 is an icon 190 and 192 is provided for a user to vote for a particular contestant. Above the video boxes 182 and 184 the number of votes each contestant has received is displayed 186 and 188. Below the video boxes 182 and 184 is a chat window, as described above. In one embodiment, a user selects the chat window 194 and enters text. In another embodiment, a user selects the chat window 194 and is required to login to the website before being granted access to contributing to the chat window.

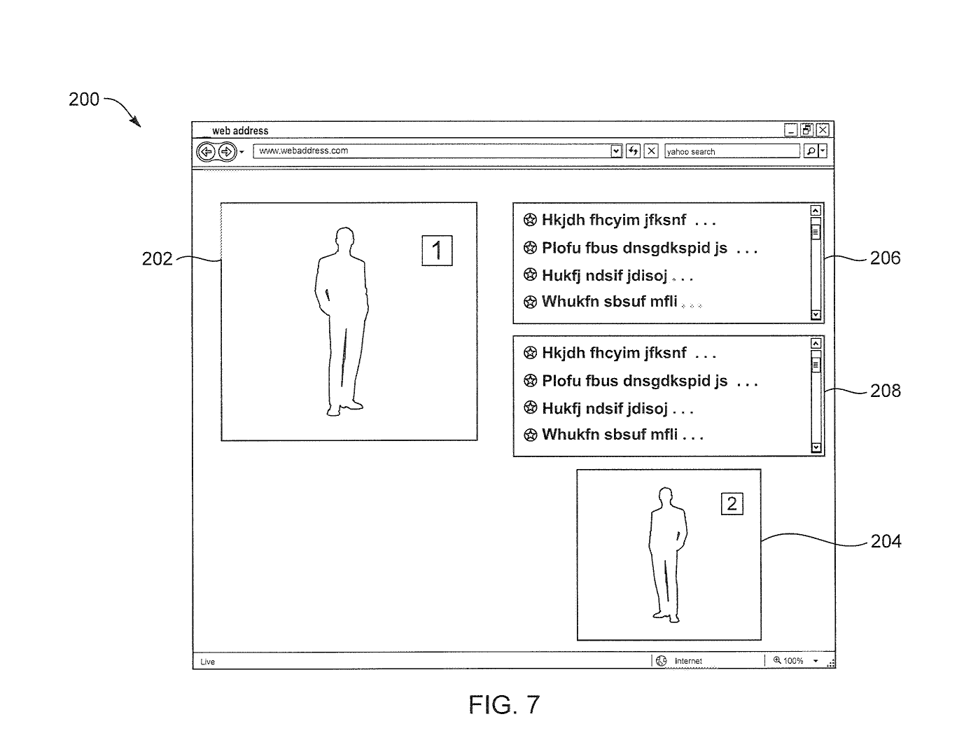

FIG. 7 illustrates an embodiment of a webpage 200, which includes two chat windows 206 and 208. These chat windows are designated for comments regarding a particular contestant. The webpage also displays two videos 202 and 204 of the contestants in a contest. In one embodiment, a user can select one of the displayed video boxes to enlarge it, as illustrated. If a user desires to so enlarge video box 204 the user can select it, which enlarges that video box and shrinks the other video box 202 displayed on the webpage. In instances where a contest has alternating performances, each video box can automatically enlarge when the contestant shown in that box is performing. Other embodiments permit various arrangements of the screen interface components discussed above or related components that provide a viewer—either a first party or second party contestant or a third party spectator—with information and input means for rating or reviewing the activities of performers.

In some embodiments, the website enables visitors to log in with a usemame and password before entering the website or before accessing functions and features of the website. New users sign up for a username by submitting personal information to the website. In some embodiments, a membership fee is associated with signing up for a username. In other embodiments, various membership options or levels are available to a user. These different options or levels grant or deny a user access to different features on the website. In one embodiment, only users with a particular membership level enter into a contest with another user. In another embodiment, only users with a particular membership level contribute comparison data when viewing a contest. In one embodiment, one membership level is that of an expert critic or commentator. A user with expert critic or commentator status has special privileges. For example, expert critics/commentators can have a weighted vote, contribute to a chat window that is restricted to critic/commentator input, and/or have other special privileges and/or abilities. In another embodiment, a contestant membership level is required for a user to compete in a contest against another user.

In some embodiments, a username is associated with a user profile and account. In some instances, user profiles are viewable by other users. User profiles can include a user's personal information, such as age, background, and skills. The user profile may also include information about a user's contest history, schedule, and preferences. For instance, a user profile may indicate the number of contests a user has participated in, won, lost, as well as indicating comparison information from prior contests. In some embodiments, a user profile indicates the membership level of the user. In some embodiments, visitors to the website or logged in users can access and review the profiles of other users, contestants, or members.

In some embodiments, the operator of the website schedules contests in advance between two or more contestants, who may be given special usemame and password or other access credentials, which may be valid for a limited duration to permit the scheduled contest. In other embodiments, a user who has obtained log in credentials may self-schedule contests with other users based on any number of criteria or limitations imposed by the operator of the website, including based on the verified or self-defined characteristics of each user.

In some embodiments, a user pays a fee to the operator of the website in order to view a contest, or in order to participate in a contest. The fee paid by a party may be provided in whole or in party to one or more of the contestants in a contest, or wholly to the operator of the website. Textual, graphical, audio, and audiovisual advertisements may be included within the web pages where third parties view contests. Payment for such advertisements may be collected by the operator of the website and may be shared with one or more of the contestants, including based on the number of third parties who have viewed the contest during which the advertisements were shown, or based on the ratings of third parties or of one or more classes of third parties.

In some embodiments, the website includes a contest page that displays current and future contests. A visitor to the website selects an ongoing contest to observe. By selecting a contest, the website directs that user to a contest page, such as those illustrated in FIGS. 4-7. In some cases, a link is provided on the contest page to contestant profiles. In one embodiment, the contest page can include a list of contestants. In some cases, the list of contestants includes links to contestant profiles. In one embodiment, a user suggests match-ups between two or more contestants. In one embodiment, the website organizes a tournament that includes a series of multiple contests. Information about the tournament may be displayed on the contest page or on a separate tournament page.

In some embodiments, the website provides a contestant webpage to each contestant who enters a contest. This webpage includes real-time video and audio data of the opposing contestant or contestants so that each contestant can observe the actions of his opponent. Referring back to FIG. 3, parties 102 and 104 (as opposing contestants) can each view the other contestant in a display screen 116 and 118 as well as hear the other contestant. In one embodiment, the image displayed on the display screen is the contestant webpage. For instance, the display screen 116 of first party 102 displays the contestant webpage. Likewise, the display screen 118 of party two 104 displays another contestant webpage, which presents to him an image of first party 102. In one embodiment, the contestant webpage displays comparison data. For instance, the contestant webpage displays a real-time running total of third party votes or ratings. However, in other embodiments, the contestants in a contest view a webpage that displays all the contestants in a contest, such as those illustrated in FIG. 4-7.

In some embodiments, the website allows contestants to customize the rules and parameters of a contest. Exemplary rules include limits of topics that can be discussed or performed, a limit on using other persons within the performance, elements that must be present in each contestant's performance, how points can be accumulated, how points can be deducted, whether a party can stop or quit during the contest, use of any objects or tools, etc. Representative parameters include time limits, team sizes, whether the contestants perform in turns or simultaneously, details on how third parties should compare the contestants, scoring or rating parameters, etc. These rules and parameters can be determined before or during a contest. In other embodiments, the website provides several types of contests that contestants can select from. The provided contest types have preset rules and parameters.

In some embodiments, contestants can review their performance after they complete a contest. In one embodiment, the website allows the contestants to watch a replay of their performance. In another embodiment, the website (that is, the storage facilities available to the master server that hosts the website) stores a digital copy of the captured audio, video, or other components of the contest and provides a link to that information on each participating contestant's profile. In another embodiment, third parties may access archival copies of contests that have previously occurred, either at the request of the third party or at a time scheduled by another third party or by the operator of the website that hosted the original real-time performance. In such circumstances, the third party viewing an archived contest may view ratings or comparison data that was recorded during the real-time performance, or may initiate or participate in ratings, voting, or comparisons that are captured at the time the archived contest is replayed. In another embodiment, the website provides a link on each participating contestant's profile permitting access to the comparison data captured from third parties that watched a contest. In yet another embodiment, the website allows contestants to immediately have access to the results of a contest. For example, once the contest is over the website may automatically present each contestant with a result's page that presents all comparison data entered by third parties, such as ratings, votes, chat window comments, or other written feedback or criticism.

In some embodiments, a mute option can be included for a competition. The mute option allows a player, host, or the website to mute the audio feed from one or more contestants for a period of time. In one embodiment, the mute option allows the other contestants to be muted while one contestant is performing. In another embodiment, the mute option allows a contestant to mute the other contestants while that contestant performs. In anther embodiment, a host or referee has control of the mute option. In yet another embodiment, the mute option can be designate by a host, referee or one or all contestants prior to the beginning of the contest.

In some embodiments, the contest is a recorded, time-delayed contest. For example a first contestant can record a performance, such as a video or audio performance and post it on the website. A second contestant can then view the first performance and then record his performance and upload it to the website. Any number of contestants can participate in this contest. In one embodiment, two contestants take turns reviewing the other's performance, performing, and uploading his performance to the website. Such a contest can include a limit of the number of performances each contestant is permitted before the contest is over and third party observers get to compare the performance.

In discussing embodiments of the present invention that relate to performances by musical or vocal artists, it should understood that similar exchanges of many types could employ many of the features of the embodiments already discussed. Two such further exemplary applications of such embodiments are as follows:

In one representative embodiment, the performers are two or more political candidates, commentators, pundits, or subject matter experts, who may be located in diverse geographic locations at the time of a real-time performance. One of the performers may be a moderator or referee that assumes a role of managing the real-time interaction as would be found in a situation where all the performers were in the same physical location. Using the embodiments discussed above, such performers may engage in a debate, critique, discussion, or other exchange, in real-time, while one or more third parties—including potentially millions of third parties simultaneously—view the exchange and submit comparison data such as votes, ratings, or comments on the policy positions, strategy, appeal, believability, appearance, electability, or other characteristics of one or more of the performers. The web page on which one or more performers or third parties view the exchange as it takes place—or as part of an archived replay as discussed above—may include facility for input of comparison data in formats specific to the nature of the performance, such as voting or rating specific characteristics such as those just enumerated, or others related to the specific performance, the specific performers, or the specific issues being addressed by the performers.

In another representative embodiment, the performers are players of video games, and rather than a video camera 110 or webcam 112, each performer provides a video stream comprising the performer's performance that is the output of a computer device on which the performer is playing the video game. This embodiment may be particularly useful, for example, where performers wish to participate in multiplayer networked games, where an embodiment of the present invention will permit third party observers to watch real-time or archived play by multiple game players who participate in the same game from geographically diverse locations. Third parties may rate or compare players' skills, strategies, and other aspects of the game. Each game player may also be given the option of viewing archived games to study a player's performances and strategies, or to learn from the comments of viewers/third parties who watched the game or otherwise provided comments, judgments, insight, or other information.

While embodiments of the present invention embrace real-time performances, those of skill in the art will appreciate that embodiments of the present invention also embrace non-real-time performances, such as pre-recorded performances.

### Website Technology

Those skilled in the art will recognize that features of the embodiments presented in the foregoing sections may be implemented by various technologies. In one embodiment, the capture of information on the computer processing system 1 17 and 119 at which a performer or contestant (such as first party 102 or second party 104) is physically located is accomplished by means of a simple application created using the Microsoft .NET application programming suite. In such an embodiment, the .NET application queries components of the local computer hardware to determine possible sources of input of the desired type, such as locating a webcam device, FireWire device, or USB device. The performer may be required to enter information such as a device name and port, or to select the appropriate items from a list that is created by the .NET application and presented to the performer for review.

When such an application is in use at the performer's site, and the performer subsequently uses a web browser or other programmatic interface to contact the website hosted by a master server, the web server software is able to interact with the NET application to collect the performance information, such as the audio-video feed of a video camera or webcam, and to use that information to construct the web pages that are fed back in real time (or, as applicable, from archived materials), to the performers or to third parties who view the contests or performances, as illustrated in FIGS. 4-7.

Version 3.5 of the Microsoft .NET programmatic interface includes an ActiveX control (a programmatic component) related to the MSN Video Conferencing functionality, that provides a helpful component in creating an appropriate .NET application for use on the local computer processing unit of a performer or contestant.

The website supporting collection of performance data from performers and delivery of webpages to performers and to third parties may be creating using any hardware or software tools known in the art. Web server software components that accept data from .NET ActiveX video controls as disclosed herein may facilitate rapid development of web server components relating to the present invention.

Collection and archival of video or audio-video information from performers using technologies such as those disclosed above may be accomplished in conjunction with standard database tools as are known in the art. For example, video streams captured during performances may be archived using Adobe Flash, Apple QuickTime, Microsoft AVI or other AVI formats, MPEG video streams, or other video or audio-video formats. Such archives may be stored using SQL databases, including Microsoft SQL Server, MySQL, and others, or using proprietary database formats.

In some embodiments, information such as video capture of performances may be archived by a third party providers, including a video archive site such as YouTube, and may thereafter be accessible from a webpage via a link to such a third party providers that is established by the website that hosts data from an embodiment of the present invention, as discussed herein.

In order to facilitate adequate performance by computer systems used to create some embodiments of the present invention, it is useful to provide a lag time test that provides a measurement of the average network delay or similar data when transferring information from one or more performers to a master server. Information provided by such a test can prove helpful in setting parameters relating to bandwidth consumption, framers per second to be captured, resolution size to capture, and similar parameters that will affect available resources and permit delivery to performers and third parties of a web page that meets expectations and provides an appropriate experience.

Thus, as discussed herein, embodiments of the present invention embrace systems and methods for dynamically delivering content for comparison. More particularly, the present invention relates to systems and methods for delivering online multimedia content in real-time and enabling comparisons of that content by others.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A system for dynamically providing content for comparison, the system: comprising:
a content recording system comprising
first content originating at a first location; and
second content originating at a second location; and
a computer device in a networked environment that is configured to receive the first and second content for display, wherein the display comprises:
the first content;
the second content; and
a comparison metric by which a comparison may be indicated between the first content and the second content recording.

2. The system of claim 1, further comprising a feedback display visible at the first location and comprising content derived from the second location.

3. The system of claim 1, wherein the comparison metric is made visible at the first location.

4. The system of claim 1, wherein the content recording system further comprises third content originating at a third location.

5. The system of claim 1, wherein the first content is received at the computer device as a real-time media stream.

6. The system of claim 1, wherein the first content and the second content are each derived from separate media recording devices capturing real-life activities occurring in real-time.

7. The system of claim 1, wherein computer device makes available within the visual display information derived from an analysis of the comparison metric.

8. The system of claim 1, wherein the first content and the second content are stored in an archival format for later access.

9. The system of claim 1, wherein the comparison metric is selected from one of: (i) a yes-no vote, (ii) a multi-step rating, and (iii) a text-based descriptive comparison.

10. The system of claim 1, wherein the second content is additive to the first content.

11. A method for dynamically providing comparison of content, the method comprising:
providing a media recording set comprising (i) first content from a first location to a networked computer device, and (ii) second content from a second location to the networked computer device;
rendering a webpage comprising (i) the first content, (ii) the second content, and (iii) a comparison metric; and
providing the webpage to a user at a third location; and
receiving comparison input from the user at the third location relating to the comparison metric.

12. The method of claim 11, further comprising a rendering the comparison input at a feedback display visible at the first location.

13. The method of claim 11, further comprising rendering the second content at the first location.

14. The method of claim 11, wherein the media recording set further comprises a third content originating at a third location.

15. The method of claim 14, wherein the third content is based upon a moderator input relating to a comparison of the first and second content.

16. The method of claim 11, further comprising obtaining the first and second media from separate media recording devices, capturing real-life activities occurring in real-time.

18. The method of claim 11, wherein the first content and the second content are stored in an archival format for later access.

19. The method of claim 11, wherein at least one of (i) the first content and (ii) the second content is rendered on the webpage in real-time.

20. A computer program product for implementing within a computer system a method for dynamically providing comparison of content, the computer program product comprising:
a computer readable medium for providing computer program code means utilized to implement the method, wherein the computer program code means is comprised of executable code for implementing the steps for:
providing a media recording set comprising (i) first content from a first location to a networked computer device, and (ii) second content from a second location to the networked computer device;
rendering a webpage comprising (i) the first content, (ii) the second content, and (iii) a comparison metric; and
providing the webpage to a user at a third location; and
receiving comparison input from the user at the third location relating to the comparison metric.

21. A webpage rendered on a computer display, the webpage comprising:
first content from a first location;
second content from a second location for comparison with the first content;
a comparison metric; and
comparison input received from one or more users, wherein the comparison input is related to at least one of (i) the first content and (ii) the second content.

22. A webpage rendered on a computer display as recited in claim 21, wherein at least one of (i) the first content and (ii) the second content is displayed in real-time.
